(19) United States
(12) Patent Application Publication
(10) Pub. No.: US 2018/0070753 A1
(43) Pub. Date: Mar. 15, 2018

(54) Receptacle Security System

(71) Applicants: Ryan James Eveloff, Los Angeles, CA (US); Michael Jay Eveloff, Los Angeles, CA (US)

(72) Inventors: Ryan James Eveloff, Los Angeles, CA (US); Michael Jay Eveloff, Los Angeles, CA (US)

(21) Appl. No.: 15/266,510

(22) Filed: Sep. 15, 2016

(51) Int. Cl. A47G 29/124; H04W 12/08; H04W 68/00; H04W 8/24; H04W 4/02; A47G 29/122

(52) U.S. Cl. CPC A47G 29/124; H04W 12/08; H04W 68/005; A47G 2029/1226; H04W 4/025; A47G 29/1225; H04W 8/24

(57) ABSTRACT

A validated receptacle security system which utilizes a variety of anti-theft sensors, easy-to-use user interfaces, identity and/or package verification systems and methods, alarm and/or alerting systems and methods, and at least one controllable locking mechanism to provide a safe, secure, and monitored receptacle, such as for package delivery and pick up. Embodiments provide a system and structure for (1) secure delivery and pickup of items while positively monitoring the internal and external environment of a secure receptacle (including providing photographic evidence that an item has in fact been deposited into the secure receptacle), (2) taking action to preserve that environment while activating locking mechanisms in response to validated delivery and pickup transactions, and (3) activating alerts and alarms, and activating or deactivating other circuits and devices, in response to theft or tampering events.

### BACKGROUND

### (1) Technical Field

This invention relates to locking security devices, and more particularly to a locking receptacle security system.

### (2) Background

With the increasing use of on-line services for shopping, door-step deliveries of packages have increased dramatically in recent years. However, while the economy has shifted from “brick and mortar” stores to direct delivery, the technology associated with ensuring delivery has not shifted. Theft of packages from doorsteps and porches claims has been estimated to amount to at least 23 million packages annually. While a variety lockable enclosures and receptacles, some with alarms and/or notification systems have been proposed, all known approaches have some deficiency in structure or operation, and are generally limited to specific enclosures or receptacles.

For example, approaches which focus on surveillance do nothing to prevent theft; enclosures or receptacles which require physical modification of a delivery/pickup location (such as a residence) may be expensive and may not be suitable for many forms of existing construction; approaches which do not provide an interlink with carrier services fail to provide closed loop tracking of packages; enclosures or receptacles which outwardly indicate that their contents have changed (e.g., when a package is delivered) invite crime as opposed to prevent crime; approaches which offer only unsecured storage fail to protect deposited items; and existing known systems are inflexible and not readily adaptable to secure a variety of receptacles.

Accordingly, there is a need for a receptacle security system which utilizes a variety of anti-theft sensors, easy-to-use user interfaces, identity and/or package verification systems and methods, alarm and/or alerting systems and methods, and a controllable locking mechanism to provide a safe, secure, and monitored receptacle. There is also a need to make such a receptacle security system readily adaptable for protection of a variety of receptacles, including package receptacles, refrigerated and/or heated receptacles, through-wall receptacles, high-value or restricted-access cabinets, and the like, using a single, unifying mechanism and user interface. The present invention addresses these needs.

### SUMMARY OF THE INVENTION

The present invention encompasses a receptacle security system which utilizes a variety of anti-theft sensors, easy-to-use user interfaces, identity and/or package verification systems and methods, alarm and/or alerting systems and methods, and a controllable locking mechanism to provide a safe, secure, and monitored receptacle.

Embodiments may include a secure receptacle configured in various ways, depending on application and desired options, and an associated access control system for monitoring the receptacle and providing access to at least one compartment within the interior of the secure receptacle if authorized. Embodiments provide state information and content status verification as well, including notification when the secure receptacle is opened, closed, and/or tampered with, or if the contents change (e.g., when a package is delivered or picked up), or if the secure receptacle is empty or not.

The secure receptacle may be fabricated of various materials, may be of any desired size or shape, and may be configured to store oversize packages or odd-shaped contents. The secure receptacle may include multiple compartments for separating contained objects and/or maintaining separate environments (e.g., air conditioned, refrigerated, heated). The access control system controls at least one associated lock mechanism for the secure receptacle, and may include user-interface devices, such as a keypad, a display screen, a speaker and/or microphone, one or more user-interface cameras, connections for external cameras, a card reader, and/or a dedicated code reader. The access control system is configured to include or be coupled to wired and/or wireless communication systems, and an alarm system, and may be powered from a variety of sources. The access control system is also configured to include or be coupled to one or more other sensors, such as anti-theft sensors, environment sensors, light and/or sound sensors, proximity sensors, lock status sensors, biometric sensors, etc.

Embodiments of the invention are particularly useful for protecting packages being delivered or picked up from locations lacking constant protection against theft or tampering. However, embodiments of the invention are readily adaptable for protection of a variety of secure receptacles, including (but not limited to) package receptacles, refrigerated and/or heated receptacles, through-wall receptacles, high-value or restricted-access cabinets and/or rooms, and the like, using a single, unifying mechanism and user interface.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1A is a front perspective view of one embodiment of a secure receptacle in a closed configuration in accordance with the present invention.

FIG. 1B is a front perspective view of the embodiment of FIG. 1 in an opened configuration.

FIG. 2 is a diagram of possible compartment configurations for embodiments of a secure receptacle in accordance with the present invention.

FIG. 3 is block diagram of one embodiment of an access control system for embodiments of a secure receptacle in accordance with the present invention.

FIG. 4 is a perspective view of a usage location that includes one embodiment of a closed secure receptacle in accordance with the present invention.

FIG. 5 is a flowchart showing a validation/access process for a typical delivery of a package to a secure receptacle controlled by an access control system in accordance with the present invention.

FIG. 6 is a flowchart showing a validation/access process for a typical pickup of a package from a secure receptacle controlled by an access control system in accordance with the present invention.

FIG. 7 is a flowchart showing a validation/access process for a typical retrieval by an authorized user of a package from a secure receptacle controlled by an access control system in accordance with the present invention, with access via a smartphone app or web page or the like.

FIG. 8 is a flowchart showing a validation/access process for a typical retrieval of a package from a secure receptacle controlled by an access control system in accordance with the present invention, with access via local identification.

FIG. 9A is a flowchart showing an anti-theft process for a secure receptacle controlled by an access control system in accordance with the present invention.

FIG. 9B is a flowchart showing an alternative anti-theft process for a secure receptacle controlled by an access control system in accordance with the present invention.

Like reference numbers and designations in the various drawings indicate like elements.

### DETAILED DESCRIPTION OF THE INVENTION

The present invention encompasses a receptacle security system which utilizes a variety of anti-theft sensors, easy-to-use user interfaces, identity and/or package verification systems and methods, alarm and/or alerting systems and methods, and a controllable locking mechanism to provide a safe, secure, and monitored receptacle.

Embodiments of the invention are particularly useful for protecting packages being delivered or picked up from locations lacking constant protection against theft or tampering. However, embodiments of the invention are readily adaptable for protection of a variety of secure receptacles, including (but not limited to) package receptacles, refrigerated and/or heated receptacles, through-wall receptacles, high-value or restricted-access cabinets and/or rooms, and the like, using a single, unifying mechanism and user interface.

Embodiments may include a receptacle configured in various ways, depending on application and desired options, and an associated access control system for monitoring the receptacle and providing access to at least one compartment within the interior of the receptacle if authorized. Embodiments provide notification when the secure receptacle is opened, closed, and/or tampered with, or if the contents change (e.g., a package is delivered or picked up).

Embodiments may include hardware and software necessary to broadcast status and state changes to home automation systems (e.g., X10, Z-Wave®, Insteon®) and to optionally receive instructions from or through such systems.

Receptacle Configuration

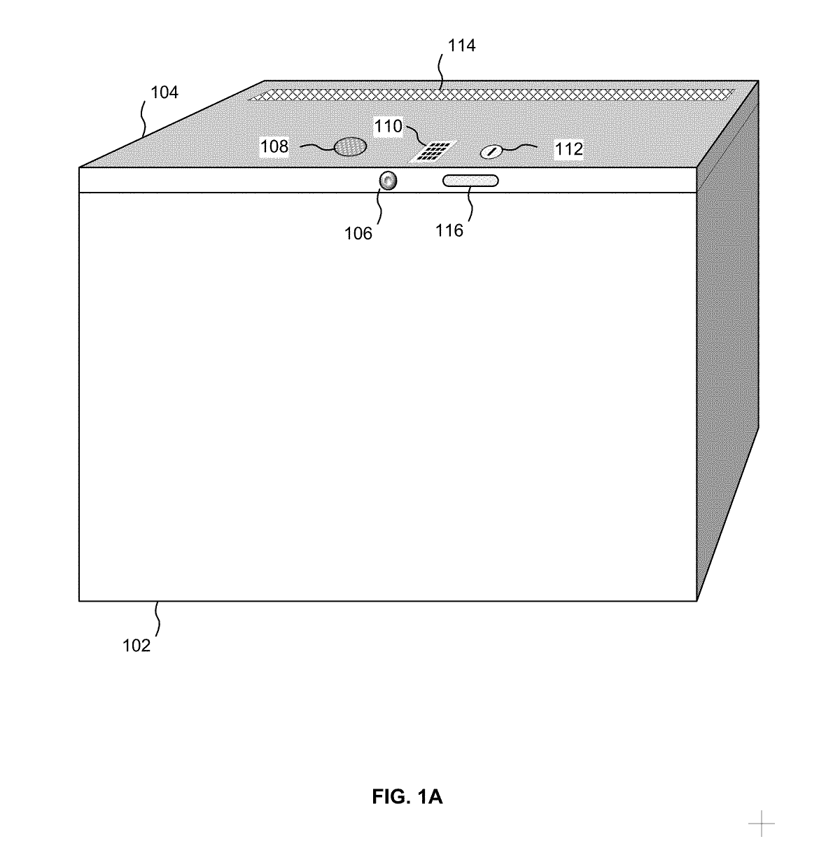

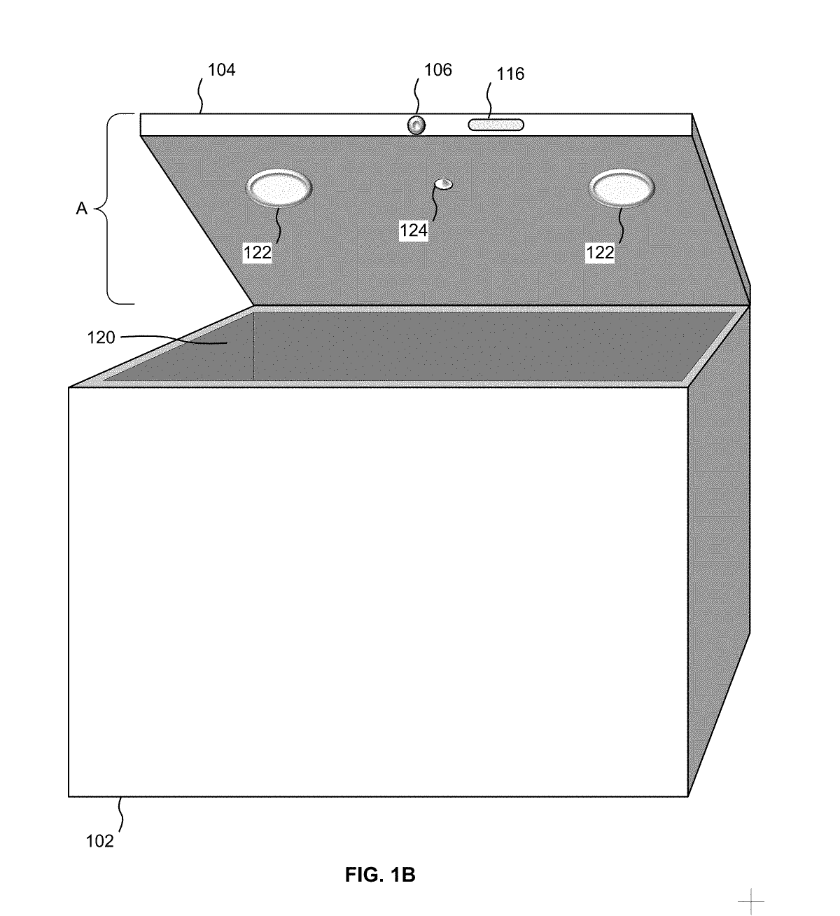

FIG. 1A is a front perspective view of one embodiment of a secure receptacle 102 in a closed configuration in accordance with the present invention. In the illustrated embodiment, the receptacle 102 includes a lockable access panel 104 that includes an access control system (described in detail below) configured to allow the access panel 104 to be opened if specific conditions are met, thereby allowing placement of an object into or removal of an object from the receptacle 102. FIG. 1B is a front perspective view of the embodiment of FIG. 1 in an opened configuration.

The receptacle 102 is intended to temporarily store an object (such as a package or a high-value and/or restricted-access item) in a secure manner, and may be an enclosure, such as shown in FIG. 1, or a defined space having a lockable access panel 104 and inaccessible from at least one location (e.g., from the exterior side of the lockable access panel 104), such as a room with a lockable door, or an opening through a wall with a lockable access panel 104 (thus providing open access to the receptacle contents from the interior side of the lockable access panel 104).

The receptacle 102 may be fabricated of various materials, such as metal, fiber composites, plastic, wood, etc., or a combination of such materials, with a view towards security against some specified level of physical attack. If intended for use in a location exposed to the weather or a wet environment (e.g., a boat), the receptacle 102 may be made of water-resistant materials, and the interface between the receptacle 102 and the lockable access panel 104 may have a gasket or other seal to improve water-resistance.

The receptacle 102 may be of any desired size or shape, and may be configured to store oversize packages or odd-shaped contents, such as dry cleaned clothes. The receptacle 102 may be freestanding (e.g., if sufficiently large and/or heavy to prevent or deter physical removal), or may be anchored or affixed to a wall, a floor, or other structure to prevent or deter physical removal. In some applications, the receptacle 102 may be configured for providing content to, or receiving content from, a robotic pickup/delivery vehicle, such as a ground-based or airborne drone.

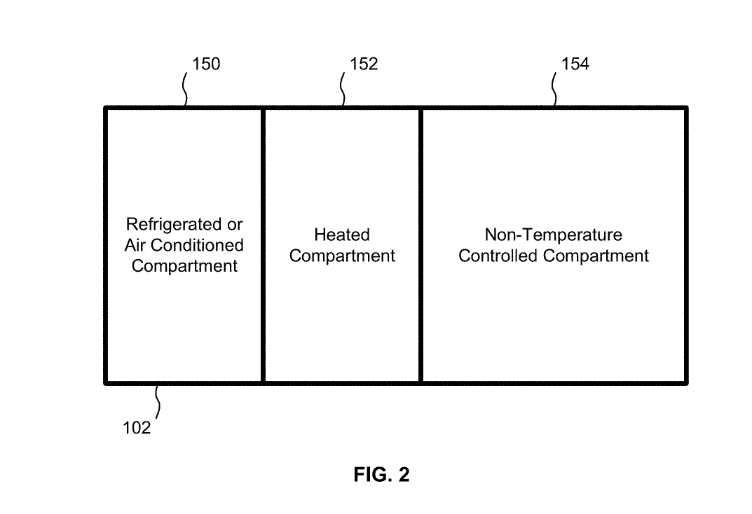

The receptacle 102 may include multiple individually or jointly accessible compartments for separating contained objects. For example, FIG. 2 is a diagram of possible compartment configurations for embodiments of a secure receptacle in accordance with the present invention. In the illustrated example, the receptacle 102 is divided into a refrigerated or air conditioned compartment 150, a heated compartment 152, and a non-temperature controlled compartment 154. As an example, the refrigerated or air conditioned compartment 150 may be for storing perishable grocery items delivered to a residence by a service provider, and the heated compartment 152 may be for storing and warming delivered hot food, such as a pizza.

As should be clear, a receptacle 102 may have any desired mix of temperature controlled and non-temperature controlled compartments (including none of a particular type). As another example, a compartment may be cooled and dehumidified (that is, air conditioned) rather than just simply refrigerated/frozen, in order to protect contents from the adverse effects of high heat and/or humidity without unduly chilling the contents (e.g., to preserve fresh flowers).

In addition, embodiments may include several secure compartments within a receptacle 102, each compartment having its own lockable access panel 104. Such separately accessible compartments may be used, for example, to provide cash compensation upon delivery for specific deliveries (e.g., receiving a pizza in a common or designated compartment while providing payment in a separate compartment only opened upon recognition and authorization of a specific delivery). Other examples of separately accessible compartments include separate pickup and delivery compartments, box delivery compartments paired with letter delivery compartments, and multi-compartment furniture such as dressers or cabinets.

The lockable access panel 104 may be configured in a variety of ways to transition between a closed state and an open state. For example, the lockable access panel 104 may be a hinged, slidable, rotatable, or pivotable lid, door, or access panel. The lockable access panel 104 may be configured to be manually opened and/or closed, or automatically opened and/or closed, or a combination thereof (e.g., automatically opened, manually closed), and may be provided with a lifting/closing assistance device (e.g., mechanical or gas springs) and/or an open-state support or stay device.

Access Control System

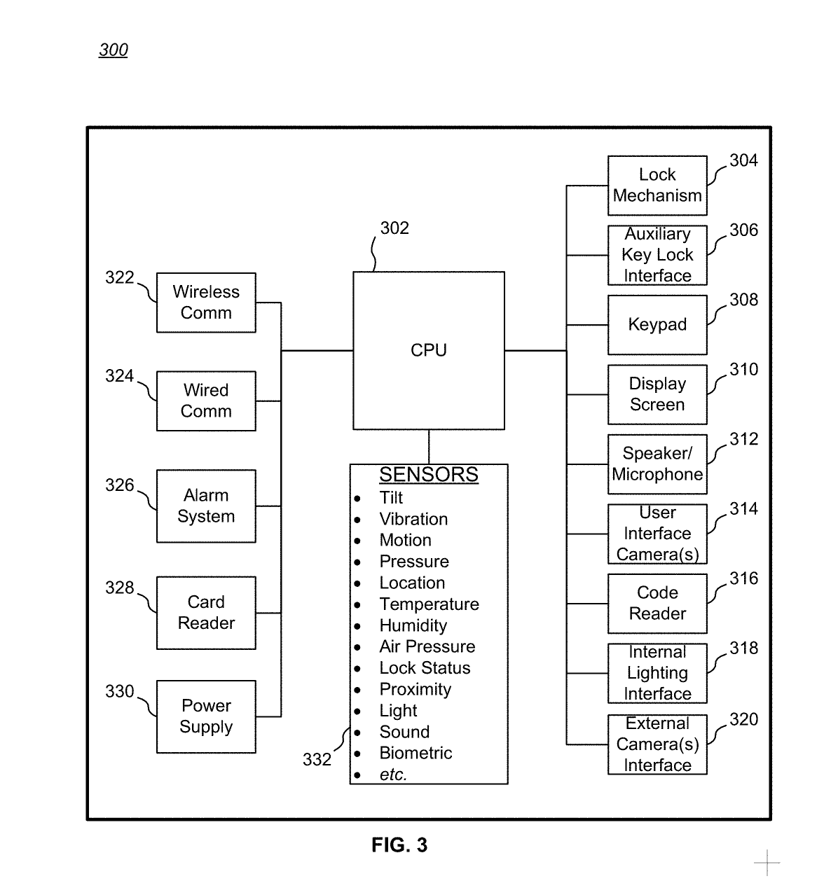

As noted above, the lockable access panel 104 in the illustrated example includes an access control system. FIG. 3 is block diagram of one embodiment of an access control system 300 for embodiments of a secure receptacle in accordance with the present invention. In the illustrated example, the access control system 300 includes a central processing unit (CPU) 302 that may be, for example, a “system on a chip” (SOC) processor available from a variety of vendors. The CPU 302 may include, or be coupled to, memory (e.g., DRAM), storage devices (e.g., solid-state memory cards or drives), input/output and/or bus interfaces (e.g., USB, PCIe), or other common computer components (not shown).

The CPU 302 is coupled to and controls at least one lock mechanism 304, which may be integral to the access control system 300 or a separate unit affixed to the receptacle 102 or to the lockable access panel 104. A lock mechanism 304 may be, by way of example, electrically actuated (e.g., a solenoid actuated bolt), electro-magnetic, or manually actuated but electrically lockable (e.g., a solenoid actuated interference device controlling a mechanically actuated bolt or latch). Alternatively, a lock mechanism 304 may include two parts, such as an electrically actuated deadbolt for unlocking the lockable access panel 104, and a manually-actuated latch handle for opening the lockable access panel 104. A lock mechanism 304 may include an auxiliary key lock to allow mechanical actuation by means of a mechanical or electronic key, separate from other actuation devices. As should be clear, a receptacle 102 may utilize multiple lock mechanisms, particularly if the receptacle 102 includes multiple individually accessible compartments.

The lock mechanism 304 may be configured to automatically lock when the lockable access panel 104 is closed, or may be configured to lock only under positive command by the CPU 302 or another component of the access control system 300. The access control system 300 may include an auxiliary key lock interface 306 to sense the open/close state of an auxiliary key lock if present.

The CPU 302 may be coupled to and interact with a number of user-interface devices (some or all of which are optional), such as a keypad 308, a display screen 310, a speaker and/or microphone 312, one or more user-interface cameras 314 or other imaging devices, and/or a dedicated code reader 316.

The keypad 308 may be used to enter an access code to directly unlock the lockable access panel 104 and/or to enter information (e.g., delivery person ID, package delivery number, etc.) that enables remote unlocking of the lockable access panel 104 by an authorized person or service or upon automated confirmation, as described below. The keypad 308 may have electromechanical (“hard”) keys or “soft” touch keys, such as are common on smartphones.

The display screen 310 may be used to provide messages to a user, such as instructions, alerts, or other information. The display screen 310 may be, for example, an LED or LCD display, and may include touchscreen and/or pen capabilities to receive input from a user. In the latter case, the keypad 308 may be part of the display screen 310.

A speaker and/or microphone 312 may be used for communication between a delivery person and an authorized person. Alternatively, one or both functions may be omitted. For example, the microphone function may be omitted while retaining the speaker function for sounding an audible alarm; conversely, the microphone function may be retained to allow voice-recognition or to allow recording of an oral message, while omitting the speaker function.

The user-interface camera(s) 314 may be positioned to image a delivery person for identity validation, or to detect presence of a person near the receptacle 102, or as evidence of such presence regardless of the manner of detection, and/or to image a package to be deposited within the receptacle 102. In the latter case, the CPU 302 may include code-reading functionality to recognize and interpret a package code, such as a barcode or a Quick Response (QR) code or the like, or may include optical character recognition (OCR) to recognize and interpret human-readable characters. The receptacle 102 may also include a dedicated code reader 316 for recognizing and interpreting a package code.

The user-interface camera(s) 314 may record single images or video images. Video images may be low-frame rate image sequences (e.g., 8 fps, to save storage space), or high-frame rate (“full motion”) image sequences (e.g., 24 fps or higher) at a desired level of resolution; higher resolutions facilitate identity validation and evidentiary value. One user-interface camera 314 may be mounted with respect to the receptacle 102 or the lockable access panel 104 such that the interior of at least one compartment within the receptacle 102 can be imaged to verify the presence of an object within the receptacle 102, as described below. The CPU 302 may include an internal lighting interface 318 to control illumination of at least one compartment within the interior of the receptacle 102 when the lockable access panel 104 is closed.

The CPU 302 optionally may include an interface for an external camera 320 for connection to one or more cameras mounted externally from the receptacle 102 so as to view the receptacle 102 and its surroundings, for detecting the presence of persons at or near the location of the receptacle 102 and preserving evidence of such detection.

In the illustrated example, the CPU 302 may be configured to include or be coupled to a wireless communication system 322, which may be a long range system (e.g., cellular telephone or other long-range RF telecommunication system), short range (e.g., WiFi, Bluetooth, or low power RF), or very short range (e.g., near field communication (NFC)). The long range function of the wireless communication system 322 readily enables communication with an authorized person or a validation service at a distance, and can provide an “internet of things” (TOT) capability. Such a person or service (more generally, an “authorizer”) would be empowered to open the lockable access panel 104 if a delivery person is making a valid delivery, and may be alerted upon unauthorized access to or attempts to access the contents of the receptacle 102, or if the receptacle 102 was being physically moved or attacked. The short range function of the wireless communication system 322 would enable capabilities similar to the long range function if interconnected with a network interface (e.g., the Internet), and may also be used to interact with local wireless devices such as security lights, alarm systems, intercoms, “smart” switches and devices such as the Insteon® product line or product lines compatible with the X10 and/or Z-Wave® protocols, and the like. The very short range function of the wireless communication system 322 would enable capabilities such as RFID-chip or smartphone based NFC identity validation.

The CPU 302 may be configured to include or be coupled to a wired communication system 324, such as a local area network (LAN) operating over Ethernet cables, a power line communication (PLC) network, a digital subscriber line (DSL) communication network, a coaxial cable-based communication network (such as networks specified by the Multimedia over Coax Alliance), and/or a serial communication connection (e.g., Universal Serial Bus (USB)).

In the illustrated example, the CPU 302 is configured to include or be coupled to an alarm system 326, to provide a locally perceptible alarm if the receptacle 102 is tampered with or moved (e.g., an audible alarm from a horn or siren, and/or flashing lights). If the alarm system 326 is triggered, an alert may be communicated through the wireless communication system 322 and/or the wired communication system 324 to an authorized person and/or an alarm service and/or law enforcement authorities. In some applications, the perceptible alarm function of the alarm system 326 may be deactivated or omitted in favor of a “silent” alarm (e.g., just an alert).

In some embodiments, the CPU 302 may be configured to include or be coupled to a card reader 328, which may serve, for example, as a credit card reader (e.g., to allow a person to open the receptacle 102 upon payment of a fee) or an identity card reader. If the card reader 328 is enabled to read credit cards, transaction and validation information may be communicated between the access control system 300 and a card processing service through the wireless communication system 322 or the wired communication system 324.

The CPU 302 is configured to be connected to an internal (e.g., battery) or external (e.g., power grid) power supply 330. In some applications, primary power may be provided by the power grid, with batteries providing backup power (e.g., an uninterruptible power supply or UPS configuration). In some outdoor applications, solar cells may be included on the exterior of the receptacle 102 to charge internal batteries. In general, an internal power supply (e.g., batteries or UPS) is preferred in order to provide power for at least the CPU 302, the anti-theft or anti-tampering sensors, the wireless communication system 322 and/or the wired communication system 324, and optionally the alarm system 326, in the event of a power failure. As should be clear, the lockable access panel 104 of the receptacle 102 should be designed to remain locked if power to the access control system 300 fails.

The CPU 302 is also configured to include or be coupled to one or more sensors 332 beyond those described above (e.g., cameras and microphone).

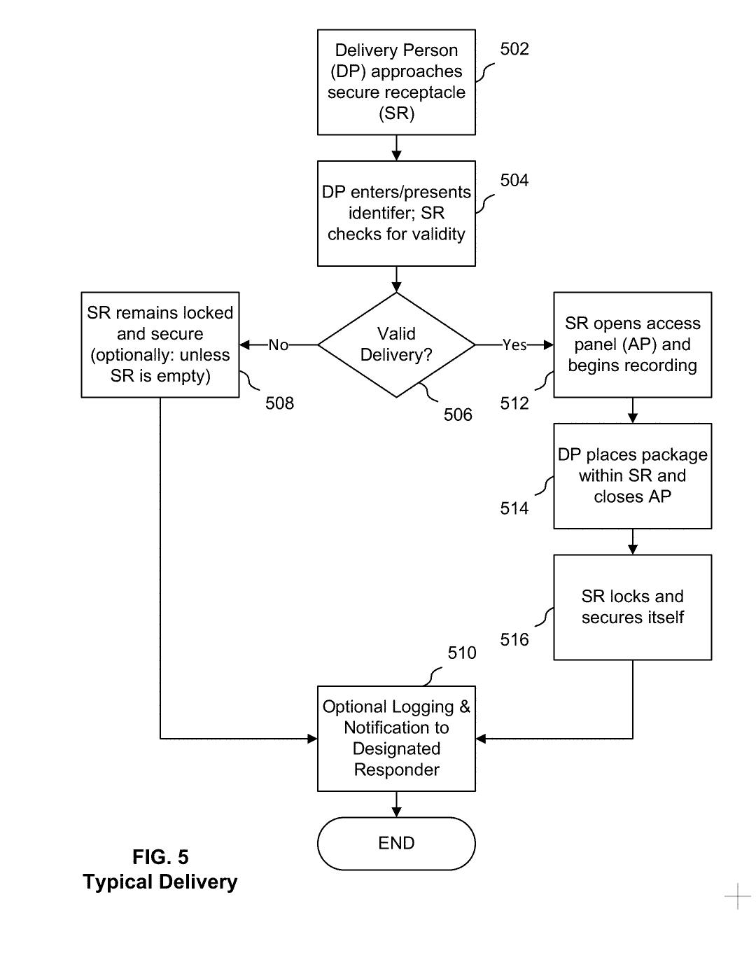

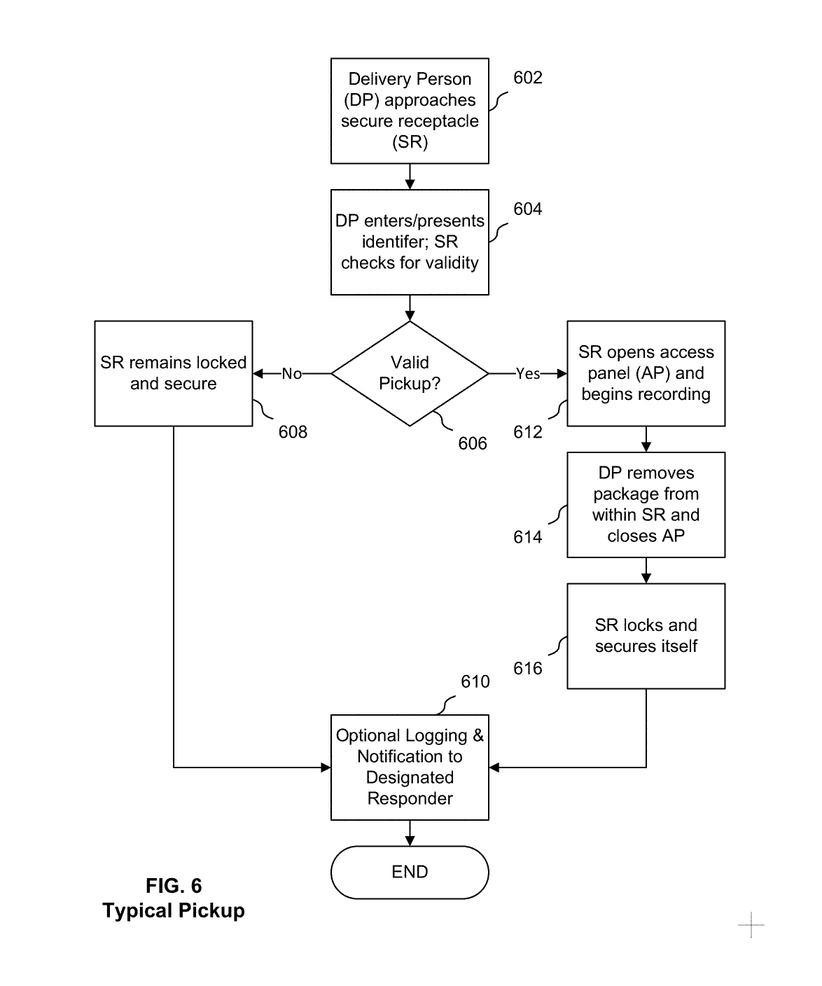

For example, one or more anti-theft or anti-tampering sensors (e.g., one or more tilt, vibration, motion, pressure, and/or location sensors) may be provided for detecting attempted physical intrusion into or appropriation or attempted appropriation of the receptacle 102. One or more tilt and/or motion sensors also may be used to determine when the lockable access panel 104 of the receptacle 102 is opening and/or closing; the display screen may change upon such an event to provide messages (e.g., instructions, alerts, or other information) to a user. One or more vibration and/or pressure sensors affixed to the top of the receptacle 102 also may be used to detect when a package has been placed on top of the receptacle 102 instead of being placed into the receptacle. The vibration sensors also may be used to detect and report improper package handling which may have damaged the contents of a package (e.g., dropping of a package into a receptacle 102). The location sensor—for example, a global positioning system (GPS) sensor—also may be used to accurately establish the current geolocation of the receptacle 102 for comparison against the expected geolocation of the receptacle 102, as well as validating the delivery address for delivered packages (see additional description below regarding FIG. 5 and FIG. 6).

One or more environment sensors (e.g., temperature, humidity, and/or air pressure sensors) may be provided for detecting environmental events that may adversely affect the contents of the receptacle 102, such as shipped food items or flowers. If equipped with temperature-controlled and/or air conditioned compartments, temperature and/or humidity sensors may be used to actively control such compartments, rather than just record readings.

One or more independent lock status sensors (e.g., a photodiode and photocell, a resistive or capacitive circuit, or a micro-switch, etc.) may be included to positively indicate the status of the lock mechanism (e.g., whether a locking bolt is in an unlocked or open state, or in a locked or closed state).

One or more proximity sensors may be provided for detecting the presence of a person at or near the location of the receptacle 102. Such proximity sensors may include passive sound based sensors (which may use the microphone 312 to listen for anomalous sounds, such as footsteps or voices), active sonar sensors, capacitive or electromagnetic field sensors, light-based sensors (including infrared or ultraviolet) such as photocells, thermal sensors, imaging sensors (which may use cameras 314, 320 connected to the CPU 302), and the like.

Additional sensors and functions that may be coupled to the CPU 302 for authorizing access to at least one compartment within the interior of the receptacle 102 may include one or more biometric sensors. Examples include a fingerprint scanner (e.g., optical or capacitive), an iris scanner, a blood vessel pattern scanner (e.g., for scanning a hand), image and/or facial recognition (e.g., using cameras 314, 320 connected to the CPU 302), voice recognition (e.g., using use the microphone 312), and/or handwriting recognition (e.g., using a display screen 310 having a touchscreen, or using a dedicated electronic pen pad, not shown).

The interfaces, sensors, and devices described above may be conveniently coupled to the CPU 302 by means of a common bus, such as Universal Serial Bus, or may be individually coupled to the CPU 302 using other busses and/or protocols. Other interfaces, sensors, and devices may be coupled to the access control system 300, or provision made for coupling additional interfaces, sensors, and devices as options (e.g., field upgrades).

Receptacle and Access Control System Examples

It should be appreciated that with modern electronics, all or nearly all of the operative elements described above for the access control system 300, including sensors and devices, can be integrated into a single small package on a par in size with a typical smartphone. However, the operative elements may also be split into different interacting components.

For example, in some embodiments, the locking mechanism for a receptacle 102 and the access control system 300 may be separate components, in order to facilitate retrofitting the access control system 300 into a receptacle 102 that already has a locking mechanism, or to customize a locking mechanism to a particular type of receptacle 102 (e.g., liquor cabinet, jewelry armoire, gun safe, etc.) without having to fully customize all of the components. As another example, in some embodiments, a locking mechanism may be integrated with an access control system 300 as a unit that may be attached to a receptacle 102, such as a jewelry box. In still other embodiments, the locking mechanism for a receptacle 102 may be remotely controllable (e.g., by RF or infrared remote control) by an access control system 300 that is not attached to the receptacle 102, but is instead (for example) mounted on a nearby post, door, or wall.

It should also be appreciated that in some applications, the access control system 300 can be fully integrated into a receptacle 102 or a component of a receptacle 102. For example, referring back to FIG. 1A and FIG. 1B, an access control system 300 is configured to fit within the lockable access panel 104. In the illustrated embodiment shown in FIG. 1A, the exterior of the lockable access panel 104 may include a camera 106 for imaging a nearby person and/or a package to be delivered, a microphone/speaker 108, a keypad 110, an auxiliary key lock 112, and a solar panel array 114 for charging internal batteries. FIG. 1A also shows an optional “mail” slot 116 for delivery of small items not requiring that the lockable access panel 104 be opened. In some embodiments, the slot 116 may be always open or be protected by a manually-displaceable storm flap; in other embodiments, the slot 116 may have an electrically-controllable cover opened or closed in a manner similar to the lockable access panel 104 itself.

FIG. 1B shows the receptacle 102 in an open state, revealing a compartment 120 within the receptacle 102. In the illustrated embodiment, the interior surface of the lockable access panel 104 includes lights 122 to illuminate the interior compartment 120 of the receptacle 102, and a second camera 124 positioned to image the compartment 120 to verify the presence or absence of an object, such as a package. In some embodiments, the bottom of the compartment 120 may be colored and/or patterned to facilitate such verification (not shown). The lights 122 may be, for example, LED or fluorescent light units. As noted above, the CPU 302 may include an internal lighting interface 318 to control illumination of the interior of the receptacle 102 by the lights 122. Alternatively, a timer switch activated by closing the lockable access panel 104 may turn the lights 122 on for a period of time while imaging occurs. In some embodiments, the bottom of a compartment or of the receptacle 102 may include a scale to weigh a deposited package.

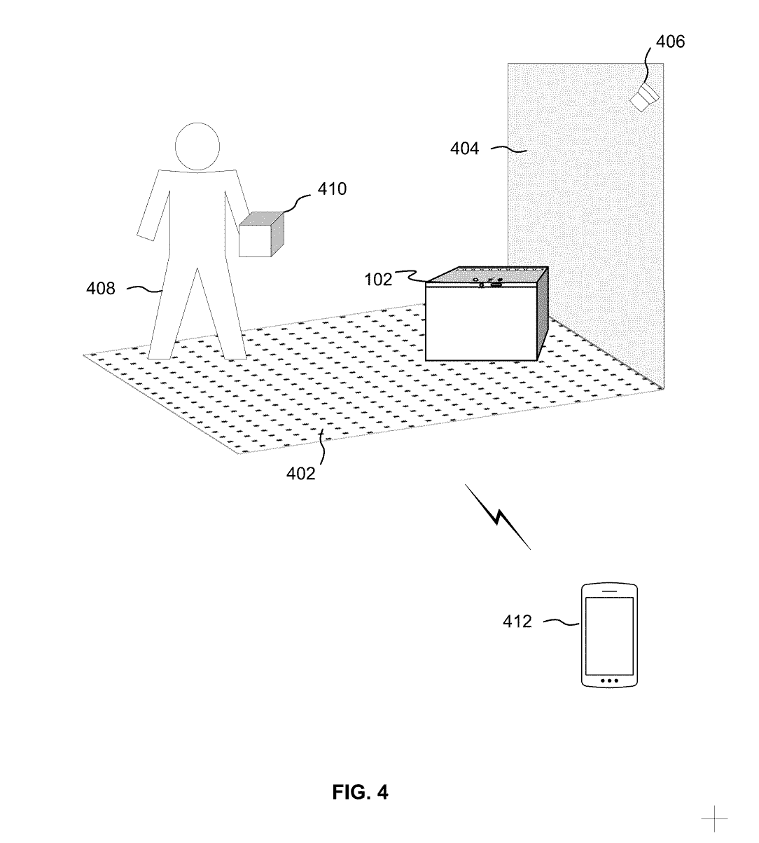

FIG. 4 is a perspective view of a usage location that includes one embodiment of a closed secure receptacle 102 in accordance with the present invention. In this example, the receptacle 102 is positioned on (and may be anchored to) a porch 402 adjacent to a wall 404 and within view of an (optional) external camera 406. As explained in greater detail below, if a delivery person 408 approaches the receptacle 102 or interacts with the receptacle 102 in a positive manner (e.g., keying in an access code on the keypad of the receptacle 102, or scanning a bar code on a package 410 being delivered), and the interaction is authenticated (e.g., by a network-connected service, or by an authorized person receiving a telecommunicated alert on a smartphone 412), a command to the access control system 300 within the lockable access panel 104 will open the locking mechanism of the receptacle 102. As should be appreciated, and as detailed below, the receptacle 102 can be used to receive packages delivered by a carrier service, or to temporarily store packages to be picked up by a carrier service.

Note that receptacles may be decorated or configured to present a more aesthetic appearance than just a plain box. For example, a receptacle for receiving packages and intended to be placed on a residential porch 402 may be configured as a padded-top bench or the like.

Operational Aspects

As should be appreciated from the above description, the access control system 300 in conjunction with a receptacle 102 provides a wide variety of ways to physically protect the contents of the receptacle 102, detect the presence of a person near the receptacle 102, detect tampering with the receptacle 102, validate the identity of a person or device (e.g., drone) wanting to access the contents of the receptacle 102, and provide controlled access to the contents of one or more compartments within the receptacle 102 to only authorized persons or devices.

For higher security of a receptacle 102, the access control system 300 may include the ability to send status notifications to an authorized user or security service regarding any of the above events, as well state information and content status verification, including notification when the secure receptacle is opened, closed, and/or tampered with, or if the contents change (e.g., when a package is delivered or picked up), or if the secure receptacle is empty or not. Such notifications may be communicated in real-time (e.g., via text messaging or telephoned voice message) as well as in summary form (e.g., daily or weekly emails with logs of events). In addition, “on-demand” status information for the access control system 300 may be accessible to an authorized user through a convenient interface, such as a web browser or smartphone application (“app”), in known fashion.

For even higher security of a receptacle 102, particularly a receptacle 102 designed for delivery and/or pickup of packages by a carrier service, a closed-loop authentication of identity system may be used. For example, such an authentication system may include an interlink with carrier services to provide closed-loop tracking of valuable goods. Accordingly, in some embodiments, the access control system 300 may communicate with a central “Receptacle Security System” (RSS) database on a hosted or authorized user-owned server which tracks all authorized users, delivery persons (by employee ID or role, for example), delivery and pickup schedules, and optionally other transactional information, such as item value, package weight, package size, etc.

As one example, FIG. 5 is a flowchart showing a validation/access process for a typical delivery of a package to a secure receptacle controlled by an access control system in accordance with the present invention. If a package is to be delivered by Carrier X to a particular secure receptacle (SR), then Carrier X may send an electronic message to the RSS database associated with the SR, the message including at least information identifying the package (e.g., the data encoded on a barcode affixed to the package), and optionally identifying the delivery person (DP) by name, employee number, or role (e.g., “validated employee of Carrier X”), as well as such other information that may be useful in identifying and validating the DP and/or delivery. The exchanged information between an authorized user of the SR and Carrier X may of course be more complex, such as including an NFC ID for the employee, the weight and/or value of the package, etc. Optionally, the authorized user may set parameters in the RSS database to program the access control system to allow only a limited by number of accesses by the carrier service, or to limit access to specific days and/or at specific times of day.

When the DP approaches the SR to deposit the package into the SR, the identity validation process begins (STEP 502). The access control system of the SR may use its proximity sensors (e.g., sonar, image recognition, etc.) to detect the presence of the DP and optionally begin recording images, video, and/or sound for evidentiary purposes. The DP may enter the package identifier or present a barcode on the package for scanning by the exterior-facing user interface camera 314, and optionally enter or present an identifier for the DP (e.g., by entering in the DP's employee number on the keypad of the SR, or by scanning an employee number on an ID badge, or by using a biometric sensor, or by using an NFC device (e.g., a smartphone) to transmit such information to the access control system 300). Optionally, if the DP uses a hand-held package tracking device, as is common with some carrier services, and the package tracking device includes GPS capability, the geolocation coordinates of the DP may be transmitted as part of the identifier information. As another option, as part of the identity validation process, the geolocation coordinates of the SR itself may be transmitted to the carrier service for real-time comparison to the geolocation coordinates of the DP, in order to ensure that the DP is at the correct delivery address. Of course, other means of identifying the package and/or the DP may be used in light of the numerous ways of interacting with the access control system described above. Note also that the fact that the DP has presented a package bearing a package identifier (e.g., a tracking number) for a package expected by the authorized user, may be a sufficient identifier for the DP. The access control system then validates the provided identifier information against the information provided by Carrier X (STEP 504).

Validating a presented package against expected delivery data helps prevent certain scenarios, such as a thief presenting a bogus package barcode to gain access to the interior of an SR. For validation, the access control system may query the RSS database to see if the entered/presented identification information matches the information provided by Carrier X. Alternatively, the RSS database may have downloaded the identifying information provide by Carrier X to the access control system of the SR, for local comparison and validation (with local validation by the access control system, Internet connectivity is not necessary at the time of validation). For added security, the transmission of such identifying information may be encrypted.

If the entered/presented identification information indicates that the delivery is not valid (STEP 506), then the SR remains locked and secure (STEP 508). As an optional variant of STEP 508, the SR may be conditionally programmed to open in those cases where the SR is determined by its internal sensors to be empty, for example, in order to accept an unexpected delivery (such as a neighbor delivering a misdirected package).

Optionally (but preferably), a notification of the failed validation is logged into the RSS database and/or sent to a designated responder, such as an authorized user (e.g., a homeowner) and/or Carrier X and/or a security service or law enforcement (STEP 510). The notification may, for example, include a copy of any recorded images, videos, and/or sound of the person who attempted access to the SR.

If the entered/presented identification information indicates that the delivery is valid (STEP 506), then the SR opens the lockable access panel (AP) to at least one compartment of the SR and commences recording images of at least the interior of the SR to verify that a package is in fact deposited within the SR (STEP 512). The DP places the package within the SR and closes the AP (STEP 514). The SR then locks the associated locking mechanism to secure the package within the SR (STEP 516); image recording may stop at that point. Optionally (but preferably), a notification of the package deposit is logged into the RSS database and/or sent to a designated responder, such as an authorized user and/or Carrier X (STEP 510). The notification may, for example, include an image of the DP, of the scanned barcode (if available), and of the deposited package, as well as a timestamp. Notification closes the loop for both the authorized user and Carrier X: both have proof of actual delivery to the SR.

As should be clear, variants of the above process may be readily implemented by suitable programming of the access control system of the SR. For example: the SR can be configured to accept or not accept delivery of packages based on an entered delivery address and/or an individual tracking number (example of the latter: allowing delivery of a package for a neighbor); the SR can be configured to accept “one-time only” deliveries from a party, and stay locked and secure for subsequent delivery attempts by or on behalf of that party; and the behavior of the SR can be configured to change depending on the internal state of the SR as determined by the internal sensors, particularly the internal camera (for instance, if the SR is verified to be empty, access to a compartment of the SR may be granted in certain circumstances as the risk associated with opening the SR is vastly reduced).

FIG. 6 is a flowchart showing a validation/access process for a typical pickup of a package from a secure receptacle controlled by an access control system in accordance with the present invention. Since a package is to be picked up by Carrier X, then an authorized user must notify Carrier X to schedule a pickup, and optionally provide a keypad code. Optionally, the authorized user may set parameters in the RSS database to program the access control system to allow only a limited by number of uses for such a code, or to limit code usage to specific days and/or at specific times of day. Carrier X may send an electronic message directly to the RSS database associated with the SR, if authorized to do so by the authorized user, or to the authorized user for entry into the RSS database. The message may include at least information identifying the package to be picked up (e.g., an assigned tracking number), and optionally information identifying the delivery person (DP).

When the DP approaches the SR to pick up the package from the SR, the identity validation process begins (STEP 602). Again, the access control system of the SR may use its proximity sensors to detect the presence of the DP and optionally begin recording for evidentiary purposes. The DP may enter the package identifier (e.g., tracking number) and/or a keypad code provided by the authorized user. The DP may optionally enter or present an identifier for the DP, as in FIG. 5. Optionally, as part of the identity validation process, the geolocation coordinates of the SR itself may be transmitted to the carrier service for real-time comparison to the geolocation coordinates of the DP, in order to ensure that the DP is at the correct pickup address. The access control system then validates the provided identifier information against the information provided by Carrier X (STEP 604).

If the entered/presented identification information indicates that the pickup is not valid (STEP 606), then the SR remains locked and secure (STEP 608). Optionally (but preferably), a notification of the failed validation is logged into the RSS database and/or sent to a designated responder, such as an authorized user and/or Carrier X and/or a security service or law enforcement (STEP 610). The notification may, for example, include a copy of any recorded images, videos, and/or sound of the person who attempted access to the SR.

If the entered/presented identification information indicates that the pickup is valid (STEP 606), then the SR opens the lockable access panel (AP) to at least one compartment of the SR and commences recording images of at least the interior of the SR to verify that a package is in fact removed from within the SR (STEP 612). The DP removes the package from within the SR and closes the AP (STEP 614). The SR then locks the associated locking mechanism to secure the SR (STEP 616); image recording may stop at that point or may continue for an additional time or while the DP remains in proximity to the SR, in order to record the actions of the DP near the location of the SR for evidentiary purposes. Optionally (but preferably), a notification of the package pickup is logged into the RSS database and/or sent to a designated responder, such as an authorized user and/or Carrier X (STEP 610). The notification may, for example, include an image of the DP and of the empty compartment within the SR, and a timestamp. Again, notification closes the loop for both the authorized user and Carrier X: both have proof of actual pickup from the SR.

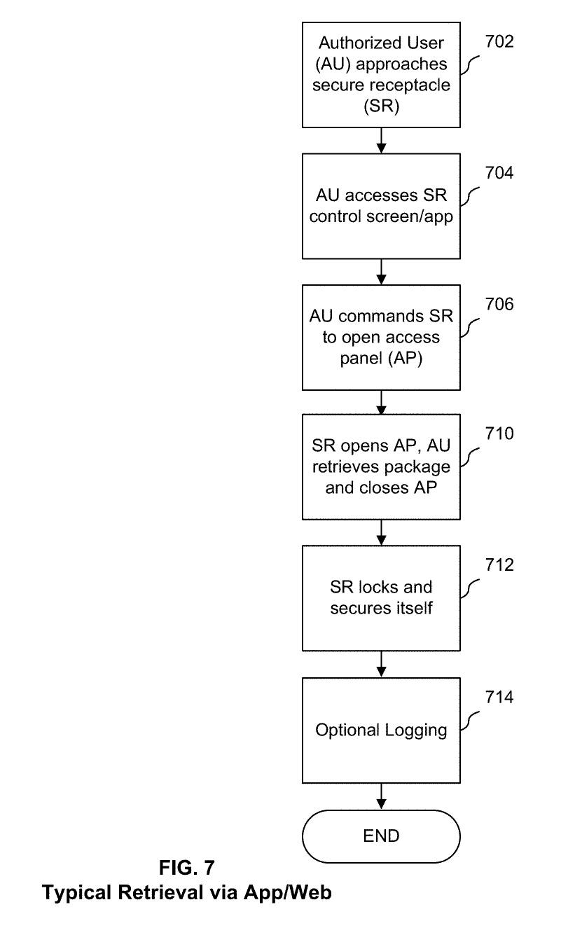

FIG. 7 is a flowchart showing a validation/access process for a typical retrieval by an authorized user of a package from a secure receptacle controlled by an access control system in accordance with the present invention, with access via a smartphone app or web page or the like. To enable this process, the access control system of an SR works in conjunction with the RSS database to pre-validate an authorized user (AU) using identifying information unique to the AU and only available if the AU accesses the RSS database in a secure manner, such as by a password login. The login may be effected through wireless communication system of the access control system (e.g., NFC, Bluetooth, WiFi, cellular network, etc.) by entry of a personal identification number (PIN) or some other code (which may be, for example, pre-programmed into the AU's smartphone, such that logging into the smartphone also automatically authenticates the user when accessing the RSS database).

When the AU approaches the SR to retrieve a package from the SR, the identity validation process begins (STEP 702); evidentiary recording may also commence. The AU accesses an application (“app”) on a secure device, such as a smartphone, or logs into a secure Internet web site. After gaining authorized access (e.g., by entering a password, PIN, fingerprint, etc.) to the app/web site, a user interface is presented to the AU (STEP 704), at which point the AU may command the SR to open the AP to the SR (STEP 706). The SR then opens at last one compartment of the SR, the AU retrieves the package from opened compartment, and the AU closes the AP (STEP 710). The SR then locks the associated locking mechanism to secure the SR (STEP 712); image recording may stop at that point. Optionally, a notification of the package retrieval is logged into the RSS database (STEP 714).

As should be clear, access to the RSS database (and thus to the access control system of an SR) through an app or web page provides an opportunity, if enabled, for an authorized user to “manually” remotely lock, unlock, and/or monitor the SR, as well as check on the status of packages within the SR and expected delivery times.

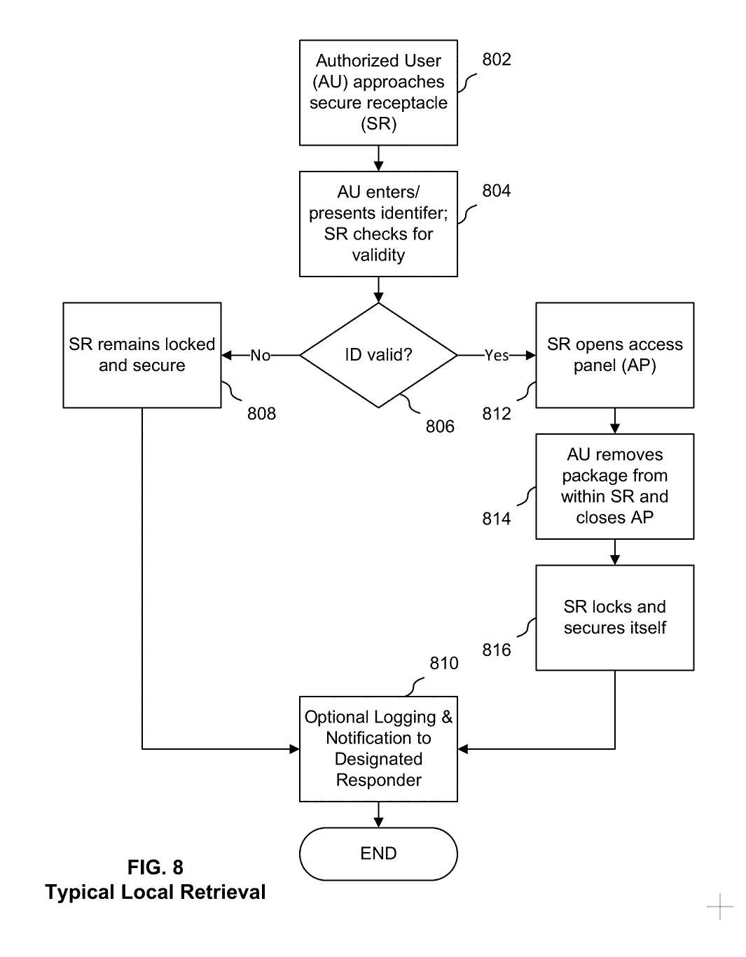

FIG. 8 is a flowchart showing a validation/access process for a typical retrieval of a package from a secure receptacle controlled by an access control system in accordance with the present invention, with access via local identification. This process allows an AU to retrieve a package from an SR without using an application or web site access, as in FIG. 7, and is similar to the pickup process shown in FIG. 6.

When an AU (who need not be the owner of the SR, but simply authorized by the owner) approaches the SR to retrieve the package from the SR, the identity validation process begins (STEP 802); evidentiary recording may also commence. The AU may enter a keypad code (e.g., a PIN), or may use a biometric sensor (e.g., fingerprint scanner, iris scanner, blood vessel pattern scanner, image/facial recognition, voice recognition, and/or handwriting recognition), or may use an NFC device (e.g., a smartphone) to transmit a previously provided code or password directly to the access control system 300. In the latter case, rightful possession of the NFC device is presumed; a secure transaction process carried out on the NFC device, such as fingerprint recognition on a smartphone, may substantially enhance security. Optionally, parameters in the RSS database may be set by the SR owner or some other person authorized by the SR owner to program the access control system to allow only a limited by number of accesses by the AU, or to limit access by the AU to specific days and/or at specific times of day. The access control system then validates the provided identifier information against information previously programmed into the RSS database and/or the access control system by the AU, or for the AU (such as by the owner of the SR) (STEP 804).

In an alternative embodiment, an AU who has approached the SR may only be initially authorized to activate a telecommunication channel to another person (e.g., the SR owner who authorized the AU to retrieve the package). In such a case, the other person may validate the identity of the AU from personal knowledge, and provide an authorization code to the access control system that allows access by the AU (such authorization code itself being subject to validation, if need be). Accordingly, in this instance, the person doing the identify validation is the “external access validating system” rather than the RSS database (directly or by download to the access control system of the SR).

If the entered/presented identification information is not valid (STEP 806), then the SR remains locked and secure (STEP 808). Optionally (but preferably), a notification of the failed validation is logged into the RSS database and/or sent to a designated responder, such as an authorized user and/or Carrier X and/or a security service or law enforcement (STEP 810). The notification may, for example, include a copy of any recorded images, videos, and/or sound of the person who attempted access to the SR.

If the entered/presented identification information is valid (STEP 806), then the SR opens the lockable access panel (AP) to at least one compartment of the SR (STEP 812). Evidentiary recording may stop at this point, since access was granted on the basis that the person validated is a known and authorized user. The AU removes a package from within the SR and closes the AP (STEP 814). The SR then locks the associated locking mechanism to secure the SR (STEP 816). Optionally, a notification of the package retrieval is logged into the RSS database and/or sent to a designated responder, such as the person or service who authorized the AU who retrieved the package (STEP 810).

Since some embodiments of the SR may include an auxiliary key lock, an AU could open an SR with a key. It may be useful to program the access control system to provide notification of a manual key lock “override” to the RSS database, in order to have a complete log of accesses.

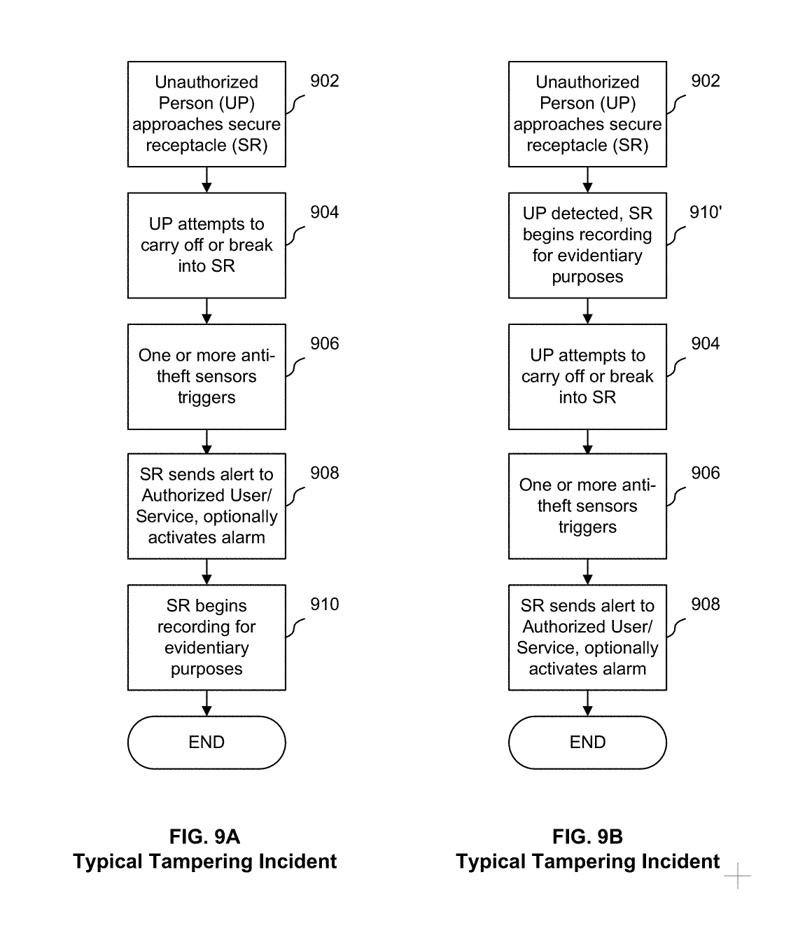

FIG. 9A is a flowchart showing an anti-theft process for a secure receptacle controlled by an access control system in accordance with the present invention. Suppose an unauthorized person (UP) approaches an SR (STEP 902). Further suppose that the UP attempts to steal the SR, or tamper with or break into the SR (e.g., by prying open the lockable access panel of the SR) (STEP 904). At that point, one or more anti-theft or anti-tampering sensors (e.g., tilt, vibration, and/or motion sensors) should be triggered (STEP 906). The SR may then send an alert to an authorized user and/or to a security service or law enforcement which includes identifying information (e.g., recording images, video, sound), and/or activate a perceptible alarm, such as a siren and/or flashing lights (STEP 908). The alarm may also include a voice warning, such as “ALERT, ALERT, TAMPERING DETECTED, YOU ARE BEING RECORDED AND THE POLICE ARE ON THEIR WAY”. The alert may also be logged into the RSS database. The SR may also begin recording for evidentiary purposes (STEP 910).

FIG. 9B is a flowchart showing an alternative anti-theft process for a secure receptacle controlled by an access control system in accordance with the present invention. The steps are essentially the same as in FIG. 9A, except that an SR equipped with proximity sensors may begin evidentiary recording upon proximity detection of the UP (STEP 910′), rather than after an anti-theft or anti-tampering sensor is triggered (STEP 910 in FIG. 9A).

In either process, optionally, the access control system may contact an authorized user or security service and allow voice or audiovisual communication with the person who triggered the anti-theft process.

Notably, in all of the processes described above, and in variant and other similar processes, the secure receptacle does not externally indicate the existence of a package or delivery, which might invite theft.

It should be clear to one of ordinary skill in the art that a number of variations, departures, and/or additions to the processes described above may be made without departing from the essence of the invention. Further, the access control system may include processes and routines for initializing interfaces, sensors, and devices, connecting to wired or wireless communication systems, error detection and warnings (e.g., if too many or too few symbols are keyed into the keypad, or a fingerprint cannot be read), powering saving (e.g., “sleep” and “wake” modes), periodic reporting (e.g., “heartbeat” or “phone home” logging) to a remote server to prove that the access control system and SR are in proper working order, timeout functions for voiding certain processes if expected events do not occur within a specified time (e.g., if keypad entry takes too long), etc.

Additional Aspects

As the above description makes sets forth, embodiments of the invention may be used to provide easy, secure, and remotely authorized and controllable access to a variety of secure receptacles. In addition, embodiments of the invention can be adapted to provide such features with respect to specific objects. For example, an embodiment of the access control system in conjunction with a suitable security mechanism (which may be an electronic lockout device, in this example) may be used to control operational access to a video game console, such as by securing the power supply and/or network connection to such a console while providing a receptacle for the console itself and/or controllers (e.g., game pads, joy sticks, motion controls, etc.) associated with such a console. The access control system of such a receptacle can be programmed to allow access to its contents (e.g., the console and/or controllers) only if authorized, and optionally separately allow enablement of power and/or network connectivity to the console only if authorized. In both cases, such authorization may be accomplished, for example, by keying in a code or by an external authorization device or process (e.g., by a parent enabling access by means of a smartphone app or a secure web page), and/or only in accordance with a specified (and customizable) schedule, in order to regulate access to the console and controls as well as to regulate play time. In this example, securing both the console and/or controllers as well as the power and/or network connectivity to the console provides added security against misuse. Such an embodiment may be useful, for example, in enforcing study habits or curfews. More generally, embodiments of the invention may be used to provide easy, secure, and remotely authorized and controllable access to an item or items associated with a dedicated secure receptacle.

Embodiments of the invention provide for a secured receptacle, access to which may be controlled both internally by an associated access control system, and externally through interaction with a Receptacle Security System (RSS) database and/or a smartphone app/web site. Accordingly, such embodiments provide a system and structure for (1) secure delivery and pickup of items while positively monitoring the internal and external environment of a secure receptacle (including providing photographic evidence that an item has in fact been deposited into or removed from the secure receptacle; more generally, utilization of a content state sensor to detect the absence or presence of a specific state for the secure receptacle—or a compartment of the secure receptacle—which is associated with the secure receptacle being “empty” or “not empty”), (2) taking action to preserve that environment while activating locking mechanisms in response to validated delivery and pickup transactions, and (3) activating alerts and alarms, and activating or deactivating other circuits and devices, in response to theft or tampering events.

### Programmed Embodiments

Some or all aspects of the invention may be implemented in hardware or software, or a combination of both (e.g., programmable logic arrays). Unless otherwise specified, the algorithms included as part of the invention are not inherently related to any particular computer or other apparatus. In particular, various general purpose computing machines may be used with programs written in accordance with the teachings herein, or it may be more convenient to use a special purpose computer or special-purpose hardware (such as integrated circuits) to perform particular functions. Thus, embodiments of the invention may be implemented in one or more computer programs (i.e., a set of instructions or codes) executing on one or more programmed or programmable computer systems (which may be of various architectures, such as distributed, client/server, or grid) each comprising at least one processor, at least one data storage system (which may include volatile and non-volatile memory and/or storage elements), at least one input device or port, and at least one output device or port. Program instructions or code are applied to input data to perform the functions described herein and generate output information. The output information is applied to one or more output devices, in known fashion.

Each such computer program may be implemented in any desired computer language (including machine, assembly, or high level procedural, logical, object oriented programming languages or a custom language/script) to communicate with a computer system, and may be implemented in a distributed manner in which different parts of the computation specified by the software are performed by different processors. In any case, the computer language may be a compiled or interpreted language. Computer programs implementing some or all of the invention may form one or more modules of a larger program or system of programs. Some or all of the elements of the computer program can be implemented as data structures stored in a computer readable medium or other organized data conforming to a data model stored in a data repository.

Each such computer program may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently, or permanently), the storage media or device being readable by a general or special purpose programmable computer for configuring and operating the computer when the storage media or device is read by the computer system to perform the procedures described above. The inventive system may also be considered to be implemented as a non-transitory computer-readable storage medium, configured with a computer program, where the storage medium so configured causes a computer system to operate in a specific or predefined manner to perform the functions described above.

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, or parallel fashion. It is to be understood that the foregoing description is intended to illustrate and not to limit the scope of the invention, which is defined by the scope of the following claims, and that other embodiments are within the scope of the claims. (Note that the parenthetical labels for claim elements are for ease of referring to such elements, and do not in themselves indicate a particular required ordering or enumeration of elements; further, such labels may be reused in dependent claims as references to additional elements without being regarding as starting a conflicting labeling sequence).

What is claimed is:

1. A receptacle security system configured for use in conjunction with a secure receptacle having at least one compartment, at least one such compartment having a corresponding access panel with a lock mechanism, the receptacle security system including:
(a) a lock mechanism interface configured to be coupled to the lock mechanism of at least one access panel, for selectively locking or unlocking the lock mechanism of such access panel to thereby provide or deny access to the compartment corresponding to such access panel;
(b) at least one user identification device for obtaining identifier information associated with at least one person authorized to access at least one compartment of the secure receptacle;
(c) at least one anti-theft or anti-tamper sensor configured to be triggered by a theft or tampering event with respect to the secure receptacle;
(d) at least one content state sensor selectively actuatable to determine the absence or presence of a specific state for one of the at least one compartments of the secure receptacle associated with being “empty” or “not empty”;
(e) at least one communication system for communicating with an external access validating system; and
(f) a control unit, coupled to the lock mechanism interface, the at least one user identification device, the at least one anti-theft or anti-tamper sensor, the at least one sensor, and the at least one communication system, for:
(1) locking or unlocking the lock mechanism of the access panel of a corresponding compartment of the secure receptacle, in conjunction with communication with the external access validating system through the at least one communication system, as a function of:
(A) verification of an item located within, removed from, or to be placed into such compartment utilizing at least the content state sensor; and
(B) validation of the identity of the person desiring access to such compartment based on identifier information obtained through the at least one user identification device; and
(2) communicating an alert through the at least one communication system to a first designated responder in response to a theft or tampering event.

2. The invention of claim 1, wherein the control unit of the receptacle security system is further for communicating a notification through the at least one communication system to a second designated responder in response to verification of an item located within, removed from, or to be placed into the corresponding compartment.

3. The invention of claim 1, wherein the receptacle security system further includes at least one proximity sensor for detecting a person approaching the receptacle security system.

4. The invention of claim 1, wherein the at least one user identification device of the receptacle security system includes at least one biometric sensor for identifying at least one person authorized to access at least one compartment of the secure receptacle.

5. The invention of claim 1, wherein the receptacle security system further includes a code reader for reading a code associated with a specific item to be placed into one compartment of the secure receptacle, wherein the control unit is further for locking or unlocking the lock mechanism as a function of the validity of the specific item as eligible to be placed into the one compartment.

6. The invention of claim 1, wherein the receptacle security system further includes at least one environmental sensor for monitoring an environmental condition of at least one compartment.

7. The invention of claim 1, wherein at least one compartment of the receptacle security system is temperature controlled.

8. The invention of claim 1, wherein the receptacle security system further includes at least one location sensor for determining the geolocation of the receptacle security system.

9. The invention of claim 1, wherein the at least one user identification device of the receptacle security system includes a keypad, and the receptacle security system further includes a display screen for displaying messages to a user.

10. The invention of claim 1, wherein the receptacle security system further includes an external camera interface configured to be coupled to one or more external cameras.

11. The invention of claim 1, wherein the receptacle security system includes a light for illuminating the interior of at least one compartment of the receptacle security system.

12. The invention of claim 1, wherein the receptacle security system further includes an alarm system for providing a locally perceptible alarm if the receptacle security system is tampered with or moved.

13. The invention of claim 1, wherein the receptacle security system further includes at least one lock status sensor configured with respect to the lock mechanism to positively indicate the locked or unlocked state of the lock mechanism.

14. The invention of claim 1, wherein at least one communication system for communicating with an external access validating system is a wireless communication system.

15. The invention of claim 1, wherein the receptacle security system further includes an internal power supply.

16. A receptacle security system configured for use in conjunction with a secure receptacle having at least one compartment, at least one such compartment having a corresponding access panel with a lock mechanism, the receptacle security system including:
(a) a lock mechanism interface configured to be coupled to the lock mechanism of at least one access panel, for selectively locking or unlocking the lock mechanism of such access panel to thereby provide or deny access to the compartment corresponding to such access panel;
(b) at least one user identification device for obtaining identifier information associated with at least one person authorized to access at least one compartment of the secure receptacle;
(c) at least one anti-theft or anti-tamper sensor configured to be triggered by a theft or tampering event with respect to the secure receptacle;
(d) at least one camera selectively actuatable to image at least an item located within, removed from, or to be placed into one of the at least one compartments;
(e) at least one communication system for communicating with an external access validating system; and
(f) a control unit, coupled to the lock mechanism interface, the at least one user identification device, the at least one anti-theft or anti-tamper sensor, the at least one camera, and the at least one communication system, for:
(1) locking or unlocking the lock mechanism of the access panel of a corresponding compartment of the secure receptacle, in conjunction with communication with the external access validating system through the at least one communication system, as a function of:
(A) verification of an image of the item located within, removed from, or to be placed into such compartment; and
(B) validation of the identity of the person desiring access to such compartment based on identifier information obtained through the at least one user identification device; and
(2) communicating an alert through the at least one communication system to a first designated responder in response to a theft or tampering event.

17. The invention of claim 16, wherein the control unit of the receptacle security system is further for communicating a notification through the at least one communication system to a second designated responder in response to verification of the image of the item located within, removed from, or to be placed into the corresponding compartment.

18. A method for secure delivery or pickup of items, including:
(a) validating the identity of a person attempting to access an interior compartment of a receptacle security system, the receptacle security system having at least one content state sensor and initially being in a secure state;
(b) upon failure of identity validation,
(1) maintaining the receptacle security system in the secure state; and
(2) communicating a notification of such failure to a first designated responder; and
(c) upon identity validation,
(1) enabling access by the identified person to the interior compartment of the receptacle security system;
(2) verifying an item located within, removed from, or to be placed into the interior compartment utilizing the at least one content state sensor; and
(3) placing the receptacle security system into the secure state.

19. The method of claim 18, further including:
(a) communicating a notification of the current contents of the interior compartment of the receptacle security system to a second designated responder.

20. The method of claim 18, further including:
(a) detecting a theft or tampering event with respect to the receptacle security system; and
(b) communicating an alert to a designated responder in response to the theft or tampering event.
